(19) United States
(12) Patent Application Publication
(10) Pub. No.: US 2021/0291995 A1
(43) Pub. Date: Sep. 23, 2021

(54) Patent application for Invention of protective and retrieval mechanisms for making unmanned aerial vehicles (UAV) and drones float on water surface to make them retrievable after a crash into water bodies.

(71) Applicant: Mahendra S. Waldia, Oro Valley, AZ (US)

(72) Inventor: Mahendra S. Waldia, Oro Valley, AZ (US)

(21) Appl. No.: 16/820,714

(22) Filed: Mar. 17, 2020

(51) Int. Cl. B64D 25/18; B64C 39/02; B64D 47/06

(52) U.S. Cl. CPC B64D 25/18; B64C 39/024; B64D 25/20; B64C 2201/146; B64C 2201/18; B64D 47/06

(57) ABSTRACT

A protective system to make drones and unmanned aerial vehicles retrievable in an event of a crash. The protective system also reduces damage from impact during a crash. The protective system will deploy automatically or manually in an event of a crash to reduce the physical impact and provide floatation on the surface of a water body. Several onboard location indicating devices for indicating the location of crashed drone or unmanned aerial vehicle are also part of the protective system.

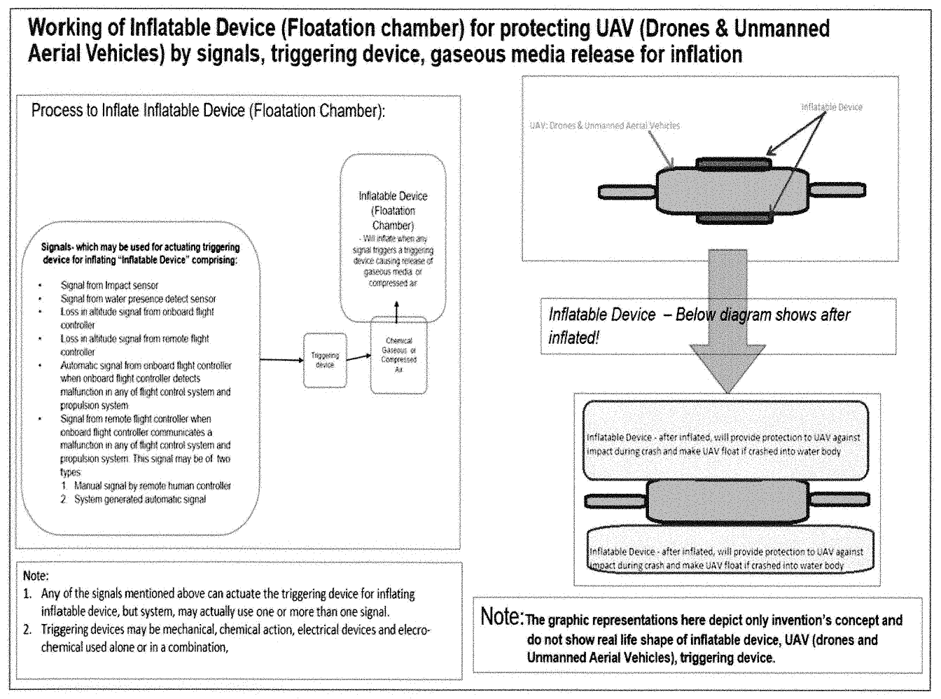

### BACKGROUND OF THE INVENTION

The applicant lost a drone which sank in a huge lake and could not be retrieved. The sinking of the crashed drone caused loss of drone, data and video footage. After the incidence, the applicant worked on an idea to conceptualize and design an inflatable floatation device to be deployed in the event of a crash of drone or unmanned aerial vehicle (UAV) in a water body or on land. For clarity, the definition of drone and unmanned aerial vehicle (UAV) in this application as applicable to said system is explained ahead in locations (0012) and (0013).

### General Description

### Definition of Water Bodies

While presenting details of the said protective and retrieval_system—it is important to explain what is meant by water bodies for the purpose of this application paper and said protective and retrieval system. Water bodies in this application paper comprises of lakes, swimming pools, sea, rivers, creeks, clogged water pools or accumulation of water or similar liquid on earth and any other planet which may have potential to drown or sink a drone or unmanned aerial vehicle (UAV).

Definition of unmanned aerial vehicles, UAV, drone or drones:

The words drone, drones and unmanned aerial vehicles will be referred as UAV in this application paper. For flying, UAV use an onboard propulsion system, an onboard flight control system and a remote command system. The onboard flight control system controls propulsion system for a proper and safe control during take-off, flying and landing. The onboard flight control system of UAV use onboard navigational devices for direction and accomplishing a flight successfully. Remote command system is used to control the flight of UAV remotely by human operators or/and computers with artificial intelligence. Remote command system is also called—“remote flight controller”.

### SUMMARY OF THE INVENTION

A UAV may crash in case of failure of any of—onboard propulsion system, onboard flight control system, navigational system or remote command system. During a flight, UAV may also crash if it collides with another object. UAV can be destroyed or lost completely if it crashes in a water body or on land. This application paper provides details of a protective and retrieval system which uses one or more of an inflatable floatation device to save a crashed UAV from sinking in a water body. The said protective and retrieval system will also reduce the impact force of crash in case, a UAV crashes on land. The said protective and retrieval system will inflate Inflatable floatation device, in case of a collision with other object, failure in propulsion system, failure in navigational flight control system or failure in remote command system. Signals from onboard sensors, and signals based on failure status of onboard systems and remote command will be used for triggering actuation device to inflate the floatation device. System will use one or more signals for triggering action.

### DESCRIPTION OF THE DRAWING

A block diagram (left half of drawing) shows sequence of operation to inflate the inflatable floatation device. Another half of drawing shows concept of inflatable floatation device before and after deployment.

### DETAILED DESCRIPTION OF THE INVENTION

The basic components of the system for floatation device are as below:
1001 Floatation device will inflate by an actuation device as explained in next point. For details of floatation device, please refer “Specifications and construction of system” sections 1, 2 and 3.
1002 Release of gaseous media into inflatable floatation device will use one or more actuation devices mentioned under ‘Specifications and construction of system” sections 3 & 12. Actuation devices may also be referred in this application paper as triggering devices.
1003 Command signal from sensors comprising of sensors mentioned at “Specifications and construction of system” sections from 4 to 6, can actuate actuation device directly to inflate floatation device. Actuation devices can also inflate floatation device after receiving a command signal from either or both of onboard flight control system and remote command system. Either or both of onboard flight control system and remote command system will send said command signal when one of the following situation will be present—a failure in propulsion system, uncontrolled or abnormal unintended loss of altitude, damage from a collision with another object, failure of flight controller and remote command system. System will also have an essential feature for a manual command signal for actuating actuation device by a person operating the remote command system. Remote command system will also have a feature to delay or override command signals to actuation devices. Some of command signals are mentioned in “Specifications and construction of system” sections 4 to 11. Types of actuation devices are mentioned in section 12.
1004 Protective and retrieval system will use audio, visual and wireless transmitting beacons to help in locating a crashed UAV site—refer “Specifications and construction of system” section 13 for more details.
1005 According to cost of UAV/drone and end users' preferences, above mentioned devices comprising floatation devices, crash site location beacons, actuation and sensing devices will be any combination of these three types: 1. Reusable components 2. Single use components 3. Combination of single use and reusable components.

Specifications and construction of system:
1. The shape of floatation device will be application specific custom shapes or simple shapes which will not be just limited to spherical, cubical or rectangular box shapes.
2. Floatation device will be made of single/multiple manmade material or naturally occurring material based fabrics.
3. Inflatable floatation device will use a gaseous media to fill itself to create buoyancy to keep UAV or drone afloat over the water surface. The filling of gaseous media will be initiated by an actuation mechanism after receiving command signal from one or more crash sensing mechanisms explained as in section 1003 earlier and below from sections 4 to 11. Gaseous media to fill floatation chamber will be comprising—
   Chemicals reagents NaN3 & KNO3 or similar.
   Compressed air.
   Both—chemical reagents & compressed air.
   The above mentioned gaseous media sources will be placed inside or outside the floatation device.
4. Mechanical impact sensor
5. Chemical water presence sensor
6. Electrical/electronic water presence sensor.
7. Command signal to actuation device based on optical altitude sensing from any or multi combination of these 3: —1. Onboard control system 2. Remote command system 3. Onboard and remote both working together.
8. Command signal to actuation device based on onboard GPS based mapping and altitude information from any or multi combination of these 3-1. Onboard control system 2. Remote command system 3. Onboard and remote both working together.
9. Manual command signal from remote command system.
10. Delayed or override command signal from remote command system.
11. Combination of one or more of—sections 4, 5, 6, 7, 8, 9 & 10.
12. For this invention, type of actuation device for the purpose of releasing gaseous media into floatation device will be any combination of—“chemical reaction based gas release, electro-chemical reaction based, electronic and electro mechanical valve releasing gaseous media, air into floatation device.
13. Retrieval Mechanism: For ease in retrieving and locating a crashed drone or UAV, this patent outlines a single or multi combination of below locating mechanisms comprising:
   Audio beacon: high decibel alarm to inform crash site location.
   Visual beacon Flashing or non-flashing light.
   Electronic beacon (also referred as transmitter) comprising—“Wi-Fi, bluetooth, GPS, cellular service, radio based technology”.

I claim:

1. A system to provide drones and unmanned aerial vehicles an ability to float and not sink in an event of crash into water bodies and reduce physical damage by providing a cushioning effect in an event of crash on land or water body, comprising,
a) both words drones and unmanned aerial vehicles in the claim will be mentioned as UAV here after,
b) usage of one or more inflatable devices on UAV to act as floatation chamber inflated by a gaseous media to provide buoyancy to make UAV float on the surface of a water body,
c) said inflatable device, when inflated is also designed to act as a shock absorbing device during the crash landing of UAV,
d) usage of a gas producing chemical media stored on board for inflating the said inflatable device,
e) in some applications, compressed air may substitute gaseous media,
f) usage of a combination of one or more different types of triggering devices for release of gaseous media to inflate the said onboard inflatable devices,
g) said triggering devices may be mechanical, chemical action, electrical, electro chemical devices used alone or in a combination,
h) said triggering devices, alone or in combination may be triggered by a single or multiple command signals, such as signal from onboard crash sensing sensors, signal from onboard water presence detect sensors, signal from onboard flight controller and wireless signal from remote wireless controller of UAV,
i) usage of on board audio and visual alarm to indicate UAV's location of crash site,
j) usage of on board transmitting wireless beacon to indicate location of crash site of UAV,
whereby, a retrievability to UAV and a protection to UAV from getting lost in water or terrain utilizing this system after a crash in water bodies or land will be provided.

2. Using an inflatable device as claimed in claim 1 to make a UAV unsinkable by making it float in a water body after a crash.

3. Using alone or a combination of manmade material and natural material based fabrics for said inflatable device in claim 1.

4. Using a mechanical impact sensing device on a UAV to trigger inflation of inflatable device of claim 1.

5. Using a chemical sensor on a UAV to sense presence of water to trigger inflation of inflatable device of claim 1.

6. Using electronic device on a UAV to sense presence of water and trigger inflation of inflatable device of claim 1.

7. Using a command signal from onboard flight controller for triggering inflation of onboard inflatable device of claim 1 after onboard flight controller senses change in altitude of UAV.

8. Using a command signal from remote flight controller for triggering inflation of onboard inflatable device of claim 1 after remote flight controller senses change in altitude of UAV.

9. Using a command signal from on board flight controller of UAV for triggering the onboard inflation device of claim 1 in the event of flight control system failure.

10. Using a command signal from on board flight controller of UAV for triggering the onboard inflation device of claim 1 in the event of onboard propulsion system failure.

11. Using a command signal from remote flight controller for triggering onboard inflatable device of claim 1 when onboard propulsion control failure or onboard flight controller failure information from the UAV is relayed to remote flight controller of UAV.

12. Using a manual command signal from remote flight controller of UAV for triggering inflatable device of claim 1.

13. Using on board audio alarm of claim 1 to indicate location of UAV after a crash.

14. Using on board visual alarm of claim 1 to indicate location of UAV after a crash.

15. Using a beacon working on Wi-Fi technology of claim 1 for locating a crashed UAV.

16. Using a beacon working on wireless Bluetooth technology of claim 1 for locating a crashed UAV.

17. Using a cellular technology beacon of claim 1 for locating a crashed UAV.

18. Using a beacon working on radio technology of claim 1 for locating a crashed UAV.

19. Using a beacon working on cellular technology of claim 1 for locating a crashed UAV.

20. Using a beacon working on GPS technology of claim 1 for locating a crashed UAV.

21. Using water and gas resistant conformal coating on electronic boards of UAV, such as, flight controller, electronic board of camera and storage media.
